(19) United States
(12) Patent Application Publication
(10) Pub. No.: US 2011/0129345 A1
(43) Pub. Date: Jun. 2, 2011

(54) PRELOADED PROPELLER BLADE ASSEMBLY

(76) Inventor: Michael Fedor Towkan, Gloucester (GB)

(21) Appl. No.: 12/975,154

(22) Filed: Dec. 21, 2010

(30) Foreign Application Priority Data
Nov. 27, 2009 (GB) 0920808.3

(51) Int. Cl. B64C 11/06; B21D 53/78

(52) U.S. Cl. 416/205; 29/889.6

(57) ABSTRACT

A propeller blade assembly (1) comprises a plurality of propeller blades (10) each connected to a hub (2) via at least one bearing assembly (3,4). Each of the blades (10) and the bearing assemblies (3,4) is preloaded, wherein the preload is applied over a preload path which includes a blade root portion (11) of each blade (10) and the bearing assemblies (3,4), and a spring (6) is provided in the preload path. In the event of wear of the components of the propeller blade assembly, the spring (6) maintains the preload force. A method of applying the preload to the propeller blade assembly (1) is also disclosed.

The present invention relates to propeller blade assemblies and methods of their manufacture.

It is known to mount variable pitch propeller blades to a hub via inner and outer sets of bearings, which allow rotational adjustment of each blade about its longitudinal axis and facilitate holding the blade in position. It is also known to preload the blade and the bearings in order to maintain their stability under high centrifugal and thrust forces experienced during operation.

GB2244525 discloses an example of a preloaded propeller blade hub assembly, comprising inner and outer race members, wherein the preloading is effected by means of a preloading ring with a screw threaded face adapted to screw onto a correspondingly threaded face of an outer race member of an outer bearing of the assembly. Tightening of the preload ring applies a preload force to the outer bearing, which force is transmitted through the blade root to the inner bearing, thus tensioning the system and bracing it against operational centrifugal and thrust forces.

There are several drawbacks to the use of preloaded bearing assemblies. Firstly, if either of the bearings is of the taper roller type, there is a requirement to continuously rotate the hub assembly during loading to ensure that the preload is correctly applied. Secondly, as wear occurs in the assembly, the preload is rapidly lost, leading to premature bearing wear and potential failure. It is also possible for the preloading ring or nut to loosen over time. Thirdly, for bearings contained within rotating assemblies such as propeller blade hubs, where the axis of the bearing is perpendicular to the axis of rotation of the assembly, the centrifugal forces experienced by the blade shaft tend to cause offloading of one or more of the bearings in the multi-stage arrangement. The inner and outer races of the bearings may become misaligned. All three effects are caused by the relaxation of the preload in the system due to relative movement of the components in the preloading loop or path, where small movements have significant effects on the retained preload.

Compensation for the offloading of the bearings is normally achieved by the application of additional preload to compensate for the effects of wear. Similarly, if the bearing cannot be continuously rotated during assembly, a similar philosophy of applying a compensating preload can be used. No account for the loss of preload due to wear is currently taken.

The present invention provides a propeller blade assembly comprising a plurality of propeller blades each connected to a hub via at least one bearing assembly, each of the blades and bearing assemblies being preloaded, wherein the preload force is applied over a preload path which includes the bearing assemblies and a root portion of the blades, and resilient biasing means are provided in the preload path.

Advantageously, play that would otherwise be introduced into the assembly under centrifugal loading in operation is taken up by the resilient biasing means. Thus the invention preserves the preload applied to the blade and the bearing assemblies. The play may be caused by bearing assembly wear, loosening of the preload ring, or any other relaxation that may occur in the propeller blade assembly. The propeller blade assembly according to the invention is of high strength and durability. A further significant advantage of the invention is that the preloading can be applied without the need for rotation of the propeller blade assembly, by setting the rate of the biasing means to give a required minimum preload.

The present invention also provides a method of manufacturing a propeller blade assembly, comprising connecting a plurality of propeller blades to a hub, each via at least one bearing assembly, whereby root portions of the propeller blades and the bearing assemblies form a preload path, and disposing a resilient biasing means in the preload path and applying a preload force over the preload path.

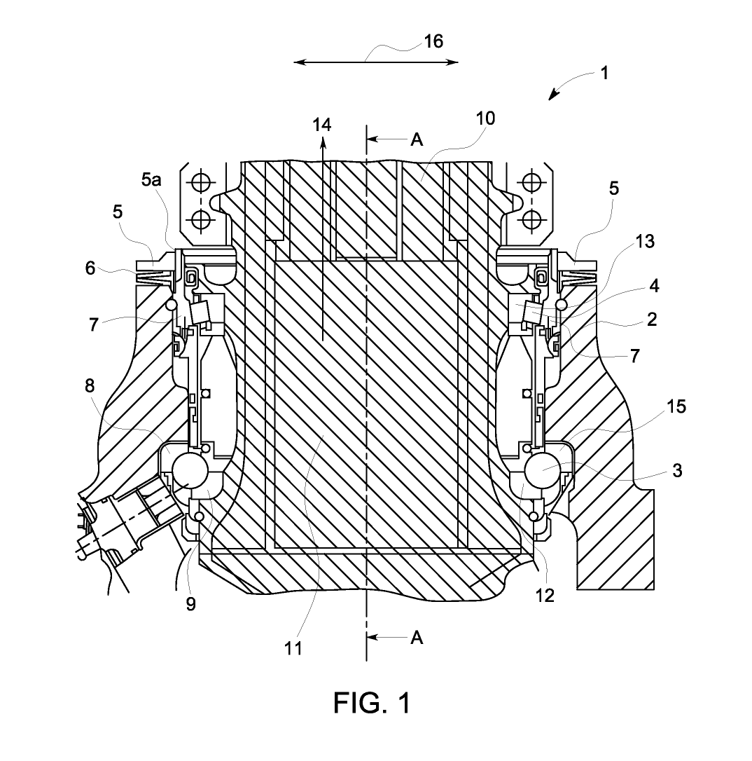

There follows a detailed description of embodiments of the invention by way of example only with reference to the accompanying drawing, in which FIG. 1 is a cross-sectional view of a propeller blade assembly cut through the centre of the assembly, wherein to the right hand side of the line A-A is shown a propeller blade assembly not incorporating the invention, and to the left hand side of the line A-A is shown a propeller blade assembly according to the invention.

FIG. 1 shows in section a propeller blade assembly 1 comprising a propeller blade 10 connected to a hub 2 via an inner bearing assembly 3 and an outer bearing assembly 4. The blade aerofoil is not shown but would be uppermost in the view of FIG. 1. The line A-A represents the axis of the blade. An arrow 14 indicates the direction of the centrifugal load during operation of the propeller. The blade 10 has a root portion 11, which is securely engaged between the inner and outer bearing assemblies 3, 4. The hub typically has 4 or 6 blades installed, equispaced around the circumference of the hub 2 such that the centrifugal load on all the blades is transmitted though the hub.

The inner bearing assembly 3 is of the ball-bearing type and comprises an inner race member 12 and outer race member 15, which are offset from one another along the axis of the blade. The structure of the inner bearing assembly 3 allows it to transmit centrifugal loading on the blade 10 to the hub 2. The outer bearing assembly 4 comprises a tapered roller bearing, having an inner race 13 and an outer race 7. The outer bearing assembly 4 transmits propeller blade thrust loads, the direction of which is indicated by an arrow 16, to the hub 2. The oblique orientation of the inner and outer race members of the outer bearing assembly 4 allows it to transmit axial forces as well. Both the inner and outer bearing assemblies 3, 4 allow the blade to twist about its axis, whereby the pitch angle of the blades can be varied.

Preloading of the assembly is effected by means of a preload ring or nut 5, which engages an outer face of the outer race 7 of the outer bearing assembly 4. In the embodiment shown, the ring 5 has a screw-threaded inner face 5a for screwing onto a correspondingly threaded outer face of the outer race 7. As the ring 5 is screwed onto the outer race member 7, it abuts a resilient biasing means 6 (or directly abuts the hub 2 on the right hand side of FIG. 1); the resilient biasing means being interposed between the preload ring 5 and the hub 2. Continued screwing of the ring 5 exerts a preloading pulling force on the outer race member 7 of the outer bearing assembly 4. The force is transmitted through the outer bearing assembly 4 to the blade root portion 11, biasing the root portion 11 in the direction of the arrow 14. The force is further transmitted through the blade root portion 11 to the inner bearing assembly 3 and thus back to the hub 2. A preload path is thereby defined including the inner and outer bearing assemblies 3, 4, the resilient biasing means 6, the blade root portion 11 and the hub 2. The inner bearing assembly 3 and the hub 2 are in compression, whereas the blade root portion 11 is in tension. The outer race member 7 of the outer bearing assembly 4 is in tension, whilst the other components of the outer bearing assembly 4 are in compression.

The resilient biasing means 6 comprises a spring 6 extending circumferentially around the propeller blade and having a diameter corresponding to that of the preload ring 5. The spring 6 comprises a washer-type spring, in particular a Belleville spring. In the embodiment shown, two Belleville springs are placed in series with one another, ie. facing in opposite directions to each other. The spring constant of the spring 6 and the spacing of the hub 2 and the preload ring 5 can be adjusted by the use of multiple springs 6 and/or shims (not shown). The spring constant is chosen to provide a force sufficient to maintain the initial preload. In particular, the spring is designed to fully compress during the preloading process.

During the manufacture of the propeller blade assembly, the step of applying a preload force can be carried out while the propeller blade assembly is stationary. In other words, there is no need to rotate the assembly during the preloading process.

When the propeller rotates, the centrifugal load on the blade 10 results in an increasing load on the inner bearing assembly 3, and a reducing load on the outer bearing assembly 4. If there is insufficient preload on the outer bearing assembly 4, the bearing, under cyclic thrust loading conditions becomes unstable and relative lateral movement occurs between the bearing races and the rollers. This results in premature bearing wear and ultimately failure of the races or rollers. The spring 6 alleviates this problem. The rate of the spring is set so that when the full centrifugal load is applied to the blade, the loss of preload resulting from play in the assembly is fully backed up by the extension of the spring 6. Provided the residual load of the spring exceeds the required preload to stabilise the outer bearing 4, the preload is maintained.

In an additional aspect of the invention, the extension of the spring 6 can be monitored during use, providing a means of indicating the amount of play in the system, and means of indicating when servicing of the propeller blade assembly 1 should be carried out.

1. A propeller blade assembly comprising a plurality of propeller blades each connected to a hub via at least one bearing assembly, each of the blades and the bearing assemblies being preloaded, wherein the preload is applied over a preload path which includes a blade root portion of each blade and the bearing assemblies, wherein a resilient biasing means is provided in the preload path.

2. A propeller blade assembly according to claim 1, wherein the root portion of each blade is connected to an inner bearing assembly and an outer bearing assembly having inner and outer race members, and the preload is applied by means of a preload ring which engages the outer race of the outer bearing assembly.

3. A propeller blade assembly according to claim 2, wherein the resilient biasing means is interposed between the preload ring and the hub.

4. A propeller blade assembly according to any of claims 1 to 3, wherein the resilient biasing means has a spring constant chosen to provide a force sufficient to maintain an initial preload.

5. A propeller blade assembly according to any of the preceding claims, wherein the resilient biasing means comprises a spring.

6. A propeller blade assembly according to claim 5, wherein the spring comprises a washer-type spring.

7. A propeller blade assembly according to claim 6, wherein the spring comprises one or more Belleville springs arranged in parallel or series to provide a desired spring rate.

8. A propeller blade assembly according to any of the preceding claims, wherein the resilient biasing means is fully compressed.

9. A method of manufacturing a propeller blade assembly, comprising connecting a plurality of propeller blades to a hub, each via at least one bearing assembly, whereby root portions of the propeller blades and the bearing assemblies form a preload path, and disposing a resilient biasing means in the preload path and applying a preload force over the preload path.

10. A method according to claim 9, wherein the step of applying a preload force is carried out while the propeller blade assembly is stationary.

11. A method according to claim 9 or 10, wherein the resilient biasing means is fully compressed in the step of applying the preload force.

12. A method according to any of claims 9 to 11, wherein the preload force is applied by screwing a preload ring onto an outer race of an outer bearing assembly.

13. A propeller blade assembly substantially as herein described with reference to the accompanying drawing.

14. A method of manufacturing a propeller blade assembly substantially as herein described with reference to the accompanying drawing.
